(19) United States
(12) Patent Application Publication
(10) Pub. No.: US 2026/0211749 A1
(43) Pub. Date: Jul. 23, 2026

(54) POWER UTILIZATION APPROXIMATION ACROSS A PLURALITY OF PROCESSING INSTANCES OF A PARALLEL PROCESSOR

(71) Applicant: International Business Machines Corporation, Armonk, NY (US)

(72) Inventors: Kaustabha RAY, Bangalore (IN); Umamaheswari DEVI, Bangalore (IN); Felix GEORGE, Kerala (IN)

(21) Appl. No.: 19/035,419

(22) Filed: Jan. 23, 2025

(51) Int. Cl. G06F 9/50

(52) U.S. Cl. CPC G06F 9/5094; G06F 9/5044

(57) ABSTRACT

A processor set may determine respective weights for a plurality of hardware resource types of hardware resources of a parallel processor device of a computer device. A processing instance, of a plurality of processing instances of the parallel processor device, is allocated a subset of the hardware resources of the parallel processor device, and the subset of the hardware resources of the parallel processor device allocated to the processing instance includes each of the plurality of hardware resource types. The processor set may determine respective resource usage values for the subset of the hardware resources allocated to the processing instance. Each resource usage value of the respective resource values is associated with a hardware resource type of the plurality of the hardware resource types. The processor set may determine an estimated power consumption of the processing instance based on the respective resource usage values and based on the respective weights.

### BACKGROUND

This disclosure relates to computer processing, and more specifically, to power utilization approximation across a plurality of processing instances of a parallel processor.

### SUMMARY

In some implementations, a computer-implemented method includes determining, by a processor set of a computer device, respective weights for a plurality of hardware resource types of hardware resources of a parallel processor device of the computer device. A processing instance, of a plurality of processing instances of the parallel processor device, is allocated a subset of the hardware resources of the parallel processor device. The subset of the hardware resources of the parallel processor device allocated to the processing instance includes each of the plurality of hardware resource types. The computer-implemented method includes determining, by the processor set, respective resource usage values for the subset of the hardware resources allocated to the processing instance. Each resource usage value of the respective resource values is associated with a hardware resource type of the plurality of the hardware resource types. The computer-implemented method includes determining, by the processor set, an estimated power consumption of the processing instance. The estimated power consumption is based on the respective resource usage values for the subset of the hardware resources allocated to the processing instance and based on the respective weights for the plurality of hardware resource types.

In some implementations, a computer system includes a processor set, one or more computer-readable storage media, and program instructions stored on the one or more computer-readable storage media to cause the processor set to perform operations. The operations include determining a plurality of scaled resource allocation values for a plurality of subsets of hardware resources allocated to a plurality of processing instances of a parallel processor device of the processor set. The plurality of subsets of hardware resources are allocated from hardware resources of the parallel processor device of the processor set. Each processing instance, of the plurality of processing instances, is allocated a subset of hardware resources of the plurality of subsets of hardware resources of the parallel processor device. Each processing instance, of the plurality of processing instances, is assigned a scaled resource allocation value of the plurality of scaled resource allocation values. The operations include determining, using a machine learning model, a plurality of estimated power consumption values for the plurality of processing instances. Each processing instance, of the plurality of processing instances, is assigned an estimated power consumption value of the plurality of estimated power consumption values. The plurality of estimated power consumption values are determined based on the plurality of scaled resource allocation values. The machine learning model is trained on a dataset comprising historical utilization metrics and corresponding historical power consumption values for the plurality of processing instances.

In some implementations, a computer program product includes one or more computer-readable storage media and program instructions stored on the one or more computer-readable storage media to perform operations. The operations include determining a plurality of scaled resource allocation values for a plurality of subsets of hardware resources allocated to a plurality of processing instances of a parallel processor device of a processor set. The plurality of subsets of hardware resources are allocated from hardware resources of the parallel processor device of the processor set. Each processing instance, of a plurality of processing instances, is allocated a subset of hardware resources of the plurality of subsets of hardware resources of the parallel processor device. Each processing instance, of a plurality of processing instances, is assigned a scaled resource allocation value of the plurality of scaled resource allocation values. The operations include determining, using a plurality of machine learning models, a plurality of estimated power consumption values for the plurality of processing instances. Each processing instance, of a plurality of processing instances, is assigned an estimated power consumption value of the plurality of estimated power consumption values. The plurality of estimated power consumption values are determined based on the plurality of scaled resource allocation values. Respective workload compositions, for each of the processing instances of the plurality of processing instances, are used to train the plurality of machine learning models.

### BRIEF DESCRIPTION OF THE DRAWINGS

FIG. 1 is a diagram of an example computing environment for power utilization approximation across a plurality of processing instances of a parallel processor described herein.

FIG. 2 is a diagram of an example implementation of distributing resources of a parallel processor across a plurality of processing instances.

FIGS. 3A and 3B are diagrams of an example implementation of power utilization approximation across a plurality of processing instances of a parallel processor.

FIG. 4 is a diagram of an example implementation of power utilization approximation across a plurality of processing instances of a parallel processor.

FIG. 5 is a diagram of an example implementation of power utilization approximation across a plurality of processing instances of a parallel processor.

FIG. 6 is a diagram of example components of a device associated with power utilization approximation across a plurality of processing instances of a parallel processor.

FIG. 7 is a flowchart of an example process associated with power utilization approximation across a plurality of processing instances of a parallel processor.

FIG. 8 is a flowchart of an example process associated with power utilization approximation across a plurality of processing instances of a parallel processor.

FIG. 9 is a flowchart of an example process associated with power utilization approximation across a plurality of processing instances of a parallel processor.

### DETAILED DESCRIPTION

The following detailed description of example implementations refers to the accompanying drawings. The same reference numbers in different drawings may identify the same or similar elements.

Efficient power management in cloud data centers is crucial for reducing costs, enhancing performance, and minimizing environmental impact. Parallel processor devices such as graphics processing units (GPUs) and artificial intelligence (AI) accelerators play a critical role in high-performance computing tasks, such as machine learning, data analytics, and/or scientific simulations, among other examples. The increasing adoption of generative AI (genAI)-based applications has led to significant projected growth for data center parallel processor devices, necessitating the development of effective strategies for improving their utilization levels and energy efficiency.

In some cases, physical resources of a parallel processor device of a computer (e.g., a server computer, a cloud data center computer) may be divided into multiple processing instances. Each processing instance may be allocated a subset of the physical resources (e.g., processing resources, memory resources, input/output (I/O) resources) of the parallel processor device so that the computer can process workloads of multiple users across the processing instances in a secure manner.

However, the power consumption of each processing instance can vary significantly depending on the workload and/or the hardware configuration, making it challenging to accurately attribute power consumption to individual processing instances. As a result, cloud operators face difficulties in providing accurate and transparent carbon reporting for each processing instance and user, which results in a reduced ability to monitor carbon emissions. Furthermore, inefficient power management can lead to increased energy waste, decreased overall system performance, and/or higher operational costs of operating the processing instances.

Some implementations described herein provide techniques for power utilization approximation across a plurality of processing instances of a parallel processor device of a computer. As described herein, a weighted technique for power utilization approximation may involve determining respective weights for a plurality of hardware resource types of hardware resources of a parallel processor device, determining respective resource usage values for a subset of the hardware resources allocated to a processing instance, and determining an estimated power consumption of the processing instance based on the respective resource usage values and weights. Additionally and/or alternatively, a machine learning technique for power utilization operation described herein may involve the use of machine learning models to estimate power consumption, and may involve training the models using data from various workloads and hardware configurations. The estimated power consumption may be used to provide accurate power monitoring and management for each processing instance and to optimize resource allocation and reduce energy waste.

In this way, the techniques described herein enable accurate power utilization approximation for a plurality of processing instances of a parallel processor device, which enables efficient power management in cloud data centers and other use cases in which hardware resources of parallel processor devices of a computer are allocated to multiple users. The machine learning techniques described herein enable the power utilization approximation for a plurality of processing instances of a parallel processor device to be adapted to various types of workloads and hardware configurations. In this way, the techniques described herein may conserve processing resources, memory resources, network resources, and/or the like, associated with inefficient power management.

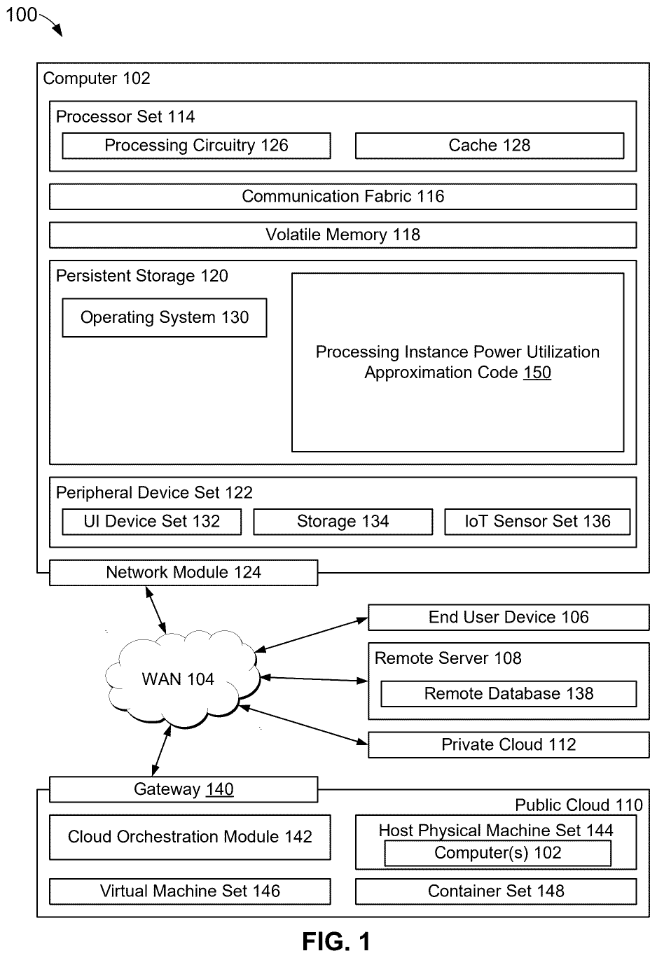

FIG. 1 is a diagram of an example computing environment 100 for power utilization approximation across a plurality of processing instances of a parallel processor described herein.

The computing environment 100 contains an example of an environment for the execution of at least some of the computer code involved in performing the inventive methods, such as processing instance power utilization approximation code 150. In addition to the processing instance power utilization approximation code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the processing instance power utilization approximation code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in processing instance power utilization approximation code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the processing instance power utilization approximation code 150 typically includes at least some of the computer code involved in performing one or more operations described herein. The operations may include, for example, determining respective weights for a plurality of hardware resource types of hardware resources of a parallel processor device of the computer device, where a processing instance, of a plurality of processing instances of the parallel processor device, is allocated a subset of the hardware resources of the parallel processor device, and where the subset of the hardware resources of the parallel processor device allocated to the processing instance includes each of the plurality of hardware resource types; determining respective resource usage values for the subset of the hardware resources allocated to the processing instance, where each resource usage value of the respective resource values is associated with a hardware resource type of the plurality of the hardware resource types; and/or determining an estimated power consumption of the processing instance, where the estimated power consumption is based on the respective resource usage values for the subset of the hardware resources allocated to the processing instance and based on the respective weights for the plurality of hardware resource types.

In some implementations, the operations may include determining a plurality of scaled resource allocation values for a plurality of subsets of hardware resources allocated to a plurality of processing instances of a parallel processor device of the processor set, where the plurality of subsets of hardware resources are allocated from hardware resources of the parallel processor device of the processor set, where each processing instance, of the plurality of processing instances, is allocated a subset of hardware resources of the plurality of subsets of hardware resources of the parallel processor device, and where each processing instance, of the plurality of processing instances, is assigned a scaled resource allocation value of the plurality of scaled resource allocation values; and/or determining, using a machine learning model, a plurality of estimated power consumption values for the plurality of processing instances, where each processing instance, of the plurality of processing instances, is assigned an estimated power consumption value of the plurality of estimated power consumption values, where the plurality of estimated power consumption values are determined based on the plurality of scaled resource allocation values, and where the machine learning model is trained on a dataset including historical utilization metrics and corresponding historical power consumption values for the plurality of processing instances.

In some implementations, the operations may include determine a plurality of scaled resource allocation values for a plurality of subsets of hardware resources allocated to a plurality of processing instances of a parallel processor device of a processor set, where the plurality of subsets of hardware resources are allocated from hardware resources of the parallel processor device of the processor set, where each processing instance, of a plurality of processing instances, is allocated a subset of hardware resources of the plurality of subsets of hardware resources of the parallel processor device, and where each processing instance, of a plurality of processing instances, is assigned a scaled resource allocation value of the plurality of scaled resource allocation values; and/or determining, using a plurality of machine learning models, a plurality of estimated power consumption values for the plurality of processing instances, where each processing instance, of a plurality of processing instances, is assigned an estimated power consumption value of the plurality of estimated power consumption values, where the plurality of estimated power consumption values are determined based on the plurality of scaled resource allocation values, and where respective workload compositions, for each of the processing instances of the plurality of processing instances, are used to train the plurality of machine learning models.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108. In some implementations, the remote server 108 is implemented by one or more computers 102 having a similar combination of components as the computer 102 illustrated in FIG. 1.

The public cloud 110 is any computer system available for use by multiple entities that provides on-demand availability of computer system resources and/or other computer capabilities, especially data storage (cloud storage) and computing power, without direct active management by the user. The computing system resources of the public cloud 110 may include a plurality of computers 102 or other devices that have a similar combinations of the computer 102 illustrated in FIG. 1. In some implementations, the computers 102 that implement the public cloud 110 may be managed in a cloud data center, and may include server blades, server racks, and/or other types of server devices.

Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers 102 of a host physical machine set 144 of the public cloud 110, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

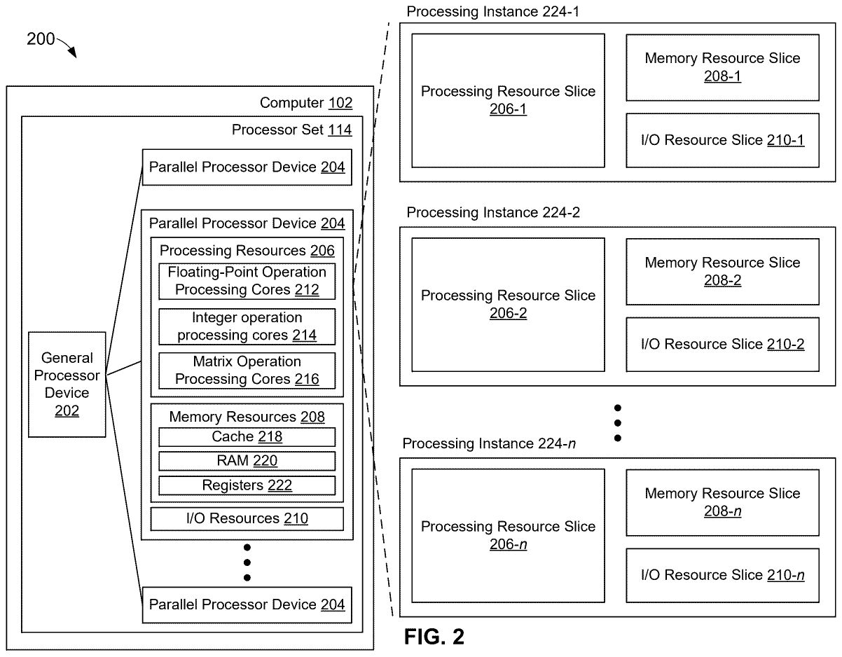

FIG. 2 is a diagram of an example implementation 200 of distributing resources of a parallel processor across a plurality of processing instances. As shown in FIG. 2, a processor set 114 of a computer 102 may include a general processor device 202 and one or more parallel processor devices 204. The computer 102 may be a standalone computer device (e.g., a desktop device, a smartphone device, a tablet device), or may be part of a remote server 108, a public cloud 110, and/or a private cloud 112. In some implementations, the computer 102 is a cloud server that is part of the host physical machine set 144 of a public cloud 110 and/or a private cloud 112 that is configured to be operated in a cloud data center or another type of data center. In these implementations, the resources (e.g., hardware resources, software resources, networking resources) of the computer 102 may be configured to be allocated to a plurality of users. The resources may be accessed remotely from another computer 102 (e.g., over a WAN 104) via a cloud environment interface.

The general processor device 202 of the computer 102 may be a CPU, a baseboard management controller (BMC), and/or another type of processor device that primarily handles sequential processing functions. The general processor device 202 may execute the operating system of the computer 102, as well as applications and database management hosted by the operating system. In some implementations, the general processor device 202 may include one or more processing cores, and may be configured to perform sequential processing functions in a single-threaded and/or in a multiple-threaded manner.

A parallel processor device 204 of the computer 102 may be a GPU, an AI accelerator, a neural processing unit (NPU), and/or another type of processor device that primarily handles parallel processing functions. As shown in FIG. 2, a parallel processor device 204 may include a plurality of types of hardware resources, such as processing resources 206, memory resources 208, and I/O resources 210, among other examples.

The processing resources 206 of a parallel processor device 204 may include many processing cores (e.g., hundreds of processing cores, thousands of processing cores, or greater). For example, a parallel processor device 204 may include a plurality of floating-point operation processing cores 212, a plurality of integer operation processing cores 214, and a plurality of matrix operation processing cores 216, among other examples. The floating-point operation processing cores 212 are hardware cores of a parallel processor device 204 that are configured to perform floating-point calculation operations. The integer operation processing cores 214 are hardware cores of a parallel processor device 204 that are configured to perform integer calculation operations. The matrix operation processing cores 216 are hardware cores of a parallel processor device 204 that are configured to perform mixed-precision matrix calculation operations.

The memory resources 208 of a parallel processor device 204 may include cache 218, RAM 220, and/or registers 222, among other examples. The cache 218 is a type of hardware resource that is configured to store frequently accessed data that is used by the processing resources 206 of the parallel processor device 204. The cache 218 may be implemented by static RAM (SRAM), dynamic RAM (DRAM), and/or another type of memory structure. The RAM 220 may be a type of hardware resource that is configured to handle large amounts of data for graphical and/or computational tasks performed by the processing resources 206. The data may include shader data, frame data, vertex data, texture data, and/or other types of data. The RAM 220 may include video RAM (VRAM) and/or another type of RAM. The registers 222 may be a type of hardware resource that is configured to store small amounts of data for computation, including instructions, addresses, and/or intermediate results.

The I/O resources 210 of a parallel processor device 204 may include memory interfaces (e.g., graphics double data rate (GDDR) interfaces, high bandwidth memory (HBM) interfaces), inter-GPU links, peripheral component interconnect (PCI) interfaces, and/or other types of I/O resources.

As further shown in FIG. 2, the hardware resources (e.g., the processing resources 206, the memory resources 208, the I/O resources 210) of a parallel processor device 204 of the computer 102 may be divided, distributed, and/or otherwise allocated across a plurality of processing instances 224-1 through 224-n. Each processing instance 224 may be served to a computer 102 (or to a plurality of computers 102) associated with one or more users. Each processing instance 224 may be accessed via a cloud environment interface or virtual machine (VM) interface (e.g., over a WAN 104).

As shown in FIG. 2, a processing instance 224 may be allocated a subset of the processing resources 206, a subset of the memory resources 208, and/or a subset of the I/O resources 210 of the parallel processor device 204. For example, a processing instance 224-1 may be allocated a processing resource slice 206-1 of the processing resources 206 of a parallel processor device 204, a memory resource slice 208-1 of the memory resources 208 of a parallel processor device 204, and/or an I/O resource slide 210-1 of the I/O resources 210 of a parallel processor device 204. A processing instance 224-2 may be allocated a processing resource slice 206-2 of the processing resources 206 of a parallel processor device 204, a memory resource slice 208-2 of the memory resources 208 of a parallel processor device 204, and/or an I/O resource slide 210-2 of the I/O resources 210 of a parallel processor device 204. A processing instance 224-n may be allocated a processing resource slice 206-n of the processing resources 206 of a parallel processor device 204, a memory resource slice 208-n of the memory resources 208 of a parallel processor device 204, and/or an I/O resource slide 210-n of the I/O resources 210 of a parallel processor device 204. In some implementations, a processing instance 224 may be allocated a plurality of processing resource slices, a plurality of memory resource slices, and/or a plurality of I/O resource slices.

In some implementations, each processing resource slice may include separate and non-overlapping hardware resources (e.g., processing resources 206) of the parallel processor device 204. For example, the processing resource slice 206-1 allocated to the processing instance 224-1 may contain floating-point operation processing cores 212, integer operation processing cores 214, and matrix operation processing cores 216 that are dedicated for use by the processing instance 224-1 (e.g., and that are secure from being used by other processing instances). As another example, the memory resource slice 208-1 allocated to the processing instance 224-1 may contain cache 218, RAM 220, and/or registers 222 that are dedicated for use by the processing instance 224-1 (e.g., and that are secure from being used by other processing instances).

FIG. 2 is provided as an example. Other examples may differ from what is described with regard to FIG. 2.

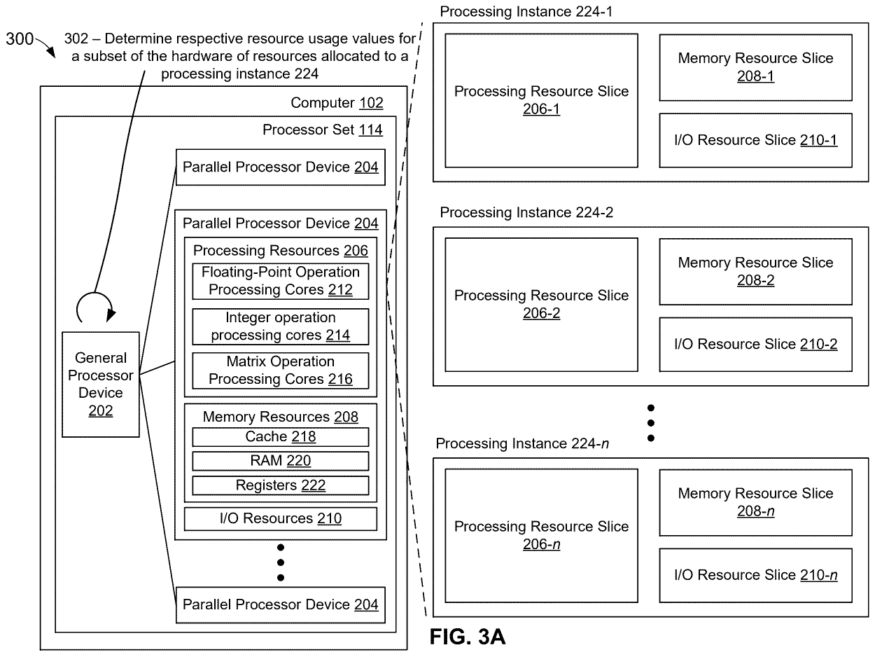

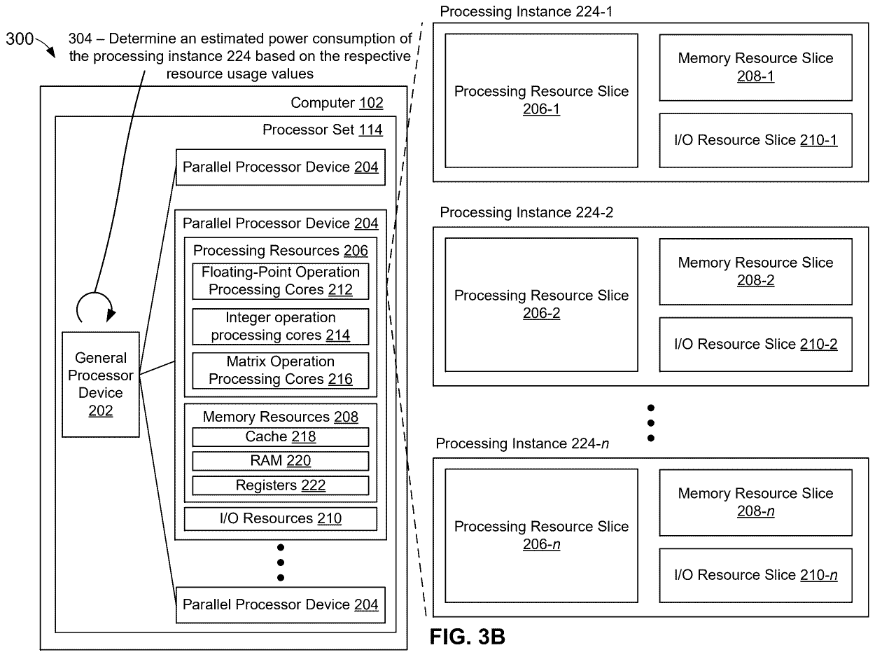

FIGS. 3A and 3B are diagrams of an example implementation 300 of power utilization approximation across a plurality of processing instances of a parallel processor. In particular, the example implementation 300 may include an example of determining respective approximated power utilizations (or estimated power consumptions) for each processing instance 224-1 through 224-n of a parallel processor device 204 of a computer 102.

As described in connection with FIGS. 3A and 3B, the approximated power utilization for a processing instance 224 may be determined using various techniques that take into consideration the resource utilization of the processing instance 224. The resource utilization of the processing instance 224, together with a weighted resource technique and/or a machine learning model technique, may be used to approximate the power utilization for a processing instance 224.

In some implementations, a general processor device 202 of a computer 102 may determine the approximated power utilization for a processing instance 224 of a parallel processor device 204 of the computer 102. In some implementations, a general processor device 202 of a first computer 102 may determine the approximated power utilization for a processing instance 224 of a parallel processor device 204 of a second computer 102. In some implementations, a general processor device 202 of a first computer 102 may determine the approximated power utilization for a processing instance 224 of a parallel processor device 204 of the first computer 102 based on receiving an instruction from a second computer 102 (e.g., a second computer 102 in the same public cloud 110 or provide cloud 112, a second computer 102 over a WAN 104).

As shown in FIG. 3A, and by reference number 302, the computer 102 (e.g., the general processor device 202 of the computer 102) may determine respective resource usage values for a subset of the hardware of resources allocated to a processing instance 224 of a parallel processor device 204. For example, the computer 102 may determine a resource usage value for the processing resource slice 206-1 allocated to the processing instance 224-1, a resource usage value for the memory resource slice 208-1 allocated to the processing instance 224-1, and/or a resource usage value for the I/O resource slice 210-1 allocated to the processing instance 224-1, among other examples.

In some implementations, the computer 102 may determine the respective resource usage values based on system parameters that are available via the operating system 130 of the computer 102. For example, the computer 102 may use the operating system 130 and/or device drivers of the parallel processor device 204 to monitor the processing cycles of the parallel processor device 204, may determine an average quantity of the processing cycles that the floating-point operation processing cores 212 of the processing resource slice 206-1 were active over a particular time interval, and may determine a resource usage value for the floating-point operation processing cores 212 of the processing resource slice 206-1 based on the average quantity of cycles.

As another example, the computer 102 may use the operating system 130 to monitor the processing cycles of the parallel processor device 204, may determine an average quantity of the processing cycles that the integer operation processing cores 214 of the processing resource slice 206-1 were active over a particular time interval, and may determine a resource usage value for the integer operation processing cores 214 of the processing resource slice 206-1 based on the average quantity of processing cycles.

As another example, the computer 102 may use the operating system 130 to monitor the processing cycles of the parallel processor device 204, may determine an average quantity of the processing cycles that the matrix operation processing cores 216 of the processing resource slice 206-1 were active over a particular time interval, and may determine a resource usage value for the matrix operation processing cores 216 of the processing resource slice 206-1 based on the average quantity of cycles.

As another example, the computer 102 may use the operating system 130 to monitor the processing cycles of the parallel processor device 204, may determine an average quantity of the processing cycles that data was sent to and/or received from the cache 218 of the memory resource slice 208-1 during a particular time interval, and may determine a resource usage value for the cache 218 of the memory resource slice 208-1 based on the average quantity of cycles.

As another example, the computer 102 may use the operating system 130 to monitor the rate of data transmitted and/or received over the I/O resources 210 of the I/O resource slice 210-1, may determine an average rate of data transmitted and/or received over the I/O resources 210 of the I/O resource slice 210-1 over the time interval, and may determine a resource usage value for the I/O resources 210 of the I/O resource slice 210-1 based on the average quantity of cycles.

In some implementations, the computer 102 (e.g., the general processor device 202 of the computer 102) may determine scaled resource usage values for each processing instance 224 based on the resource usage values that the computer 102 determined for each processing instance 224. A scaled resource usage value for a hardware resource type may be determined based on the percentage of the hardware resources of the parallel processor device 204 allocated to the processing instance 224-1, and based on relative utilization of the allocated hardware resources relative to the fraction of the resources of the parallel processor device 204 allocated to the processing instance 224-1. For example, for the processing instance 224-1, the computer 102 may determine a scaled floating-point operation processing core resource usage value based on the resource usage value determined for the floating-point operation processing cores 212 of the processing resource slice 206-1, and based on a percentage of the floating-point operation processing cores 212 of the parallel processor device 204 allocated to the processing instance 224-1. The computer 102 may determine similar scaled resource usage values for other hardware resource types of the processing instance 224-1 (and for other processing instances 224 of the parallel processor device 204). In some implementations, the computer 102 determines a scaled resource usage vector Uᵢ for the processing instance 224-1. The scaled resource usage vector for the processing instance 224-1 may include a combined scaled resource usage value for all of the hardware resource types.

As shown in FIG. 3B, and by reference number 304, the computer (e.g., the general processor device 202 of the computer 102) may determine an estimated (or approximated) power consumption of a processing instance 224 based on the resource usage value (or based on the scaled resource usage value) determined for the processing instance 224.

In some implementations, the computer 102 uses a weighted technique to determine the estimated power consumption of a processing instance 224. The weighted technique may include determining respective weights for each of the hardware resource types of hardware resources of a parallel processor device 204 allocated to the processing instance 224, and determining an estimated power consumption of the processing instance 224 based on the resource usage value and the respective weights. The weights may be selected based on the relative power consumption of the different hardware resource types. The computer 102 may determine the weights for the hardware resource types in implementations in which the power consumption of the hardware resource types are additive linear functions of utilization of the hardware resource types. The computer 102 may determine a weight for the floating-point operation processing cores 212 of the parallel processor device 204, a weight for the integer operation processing cores 214 of the parallel processor device 204, a weight for the matrix operation processing cores 216 of the parallel processor device 204, a weight for the cache 218 of the parallel processor device 204, and so on. The computer 102 may generate a weight vector for the determined weights of the hardware resource types, and the weight vector may be applied to the scaled hardware resource usage value for the processing instance 224 to determine the estimated power consumption of the processing instance 224.

In some implementations, the computer 102 determines a weight for a hardware resource type based on the operating frequency of the hardware resource type. In some implementations, the computer 102 determines respective weights for each of a plurality of operating frequencies for a hardware resource type.

For the hardware resource types allocated to the processing instance 224, the computer 102 may determine an active power component of the estimated power consumption of the processing instance 224 (e.g., a portion of the estimated power consumption that occurs when the hardware resources allocated to the processing instance 224 are actively processing a workload). Based on the weights for the hardware resource types and based on the resource usage value (e.g., the scaled resource usage value) for the processing instance 224. For example, the computer 102 may determine an active power component of the estimated power consumption of allocated hardware resources, such as the floating-point operation processing cores 212, the integer operation processing 214, the matrix operation processing cores 216, the memory resources 208, allocated to the processing instance 224 based on the weights for these hardware resource types and based on the resource usage values (e.g., the scaled resource usage values) for the processing instance 224. The computer 102 may scale the active power component of the processing instance 224 based on the overall active power consumption of the parallel processor device 204, and based on the overall resource usage of the parallel processor device 204:

$$Active Power = Parallel Processor Active Power \times \frac{( W \cdot {U}_{i}^{T} )}{( W \cdot {U}^{T} )}$$

where W is the weight vector determined for the hardware resources, Uᵢ is the scaled resource usage value vector of the processing instance i for the hardware resources (e.g., e.g. [0.3, 0.4, 0.6, 0.8] corresponding to floating-point operation processing cores 212, integer operation processing cores 214, matrix-operation processing cores 216, memory resources 208), and U is the aggregate resource usage vector for the different resource types across all of the processing instances 224-1 through 224-n. Uᵢ^{T} and U^{T} are the transposes of Uᵢ and U, respectively. The computer 102 may determine the active power component of the estimated power consumption of other processing instances 224 in a similar manner.

The computer 102 may determine an idle power component of the estimated power consumption of the processing instance 224 based on the allocation of hardware resources (e.g., the percentage of hardware resources) of the parallel processor device 204 allocated to the processing instance 224. The idle power component is the estimated power consumption of the processing instance 224 when the hardware resources allocated to the processing instance 224 are at idle and not in use (e.g., not being used other than to maintain operation of the operating system 130 and other baseline functions). For example, the computer 102 may determine an idle power component of the estimated power consumption of the processing instance 224 by multiplying the overall idle power consumption of the parallel processor device 204 by the percentage of hardware resources of the parallel processor device 204 allocated to the processing instance 224.

The computer 102 may determine the estimated power consumption of the processing instance 224 as a combination of the active power component and the idle power component. For example, the computer 102 may add the idle power component to the active power component to determine the estimated power consumption of the processing instance 224.

Additionally and/or alternatively to the weighted technique, the computer 102 may determine an estimated power consumption (e.g., an approximated power utilization) for a processing instance 224 using a machine learning model technique. The computer 102 may use the machine learning model technique in implementations in which the power consumption of the hardware resource types are not additive linear functions of utilization of the hardware resource types. In addition, the workloads (e.g., the workload types, the workload compositions) handled by the processing instances 224-1 through 224-n may affect or influence the power consumption of the processing instances 224-1 through 224-n, in addition to the resource utilization and the hardware resource type allocation for the processing instances 224-1 through 224-n. The workload handled by a processing instance 224 may affect the power consumption of the hardware resources allocated to the processing instances 224 in that the workload may utilize the hardware resources more or less efficiently than other workloads, may utilize the hardware resources more or less consistently than other workloads, and/or may have other variations relative to other workloads.

The computer 102 may select a machine learning model such as a Random Forest model or a Gradient Boosting model that has been trained on a dataset that includes historical utilization metrics and corresponding historical power consumption values for the parallel processor device 204 or the aggregate of plurality of processing instances 224. The dataset may include data from a plurality of workloads handled by the plurality of processing instances 224 and associated historical power consumption values.

In some implementations, the computer 102 uses a unified machine learning model to estimate the power consumption of processing instances 224-1 through 224-n. The unified machine learning model may be a model that is trained on historical workloads and historical power consumption values aggregated across all of the processing instances 224-1 through 224-n. The unified model may also be constructed based on historical resource utilization and power consumption values corresponding to a representative set of workloads that are executed on the parallel processor device 204, either concurrently using a plurality of processing instances or independently over several runs at different times. This historical data is used to train the unified machine learning model so that the computer 102 can apply the same unified machine learning model across the processing instances 224-1 through 224-n for determining respective estimated power consumptions of processing instances 224-1 through 224-n with low estimation error.

The computer 102 may use the unified machine learning model to estimate the power consumption of processing instances 224-1 through 224-n by providing the resource utilization values (e.g., the scaled resource utilization values) for the allocated resources for the processing instances 224-1 through 224-n, and the workload types and workload profiles for the processing instances 224-1 through 224-n, as input to the machine learning model, and may use the machine learning model to generate outputs based on the inputs. The computer 102 may use the machine learning model to generate outputs that correspond to respective estimated power consumptions of processing instances 224-1 through 224-n, where the outputs are based on the workload types and profiles, as well as the resource utilization values for the allocated resources for the processing instances 224-1 through 224-n.

The estimated power consumption determined for a processing instance 224 by the computer 102 using the unified machine learning model may have an active power consumption component and an idle power consumption component. The computer 102 may subtract the idle power consumption component of the estimated power consumption determined for a processing instance 224 according to:

$${P}_{est} ( {PI}_{i} ) = {P}_{est} ( {PI}_{i} ) - {P}_{idle} + {P}_{idle} \times {r}_{f} ( {PI}_{i} )$$

where the estimated power consumption Pₑₛₜ of processing instance i (PIᵢ) is determined as the idle power consumption component P_{idle} subtracted from the estimated power consumption Pₑₛₜ of processing instance i, plus the product of the power consumption component P_{idle} and the percentage of hardware resources of the parallel processor device 204 allocated to the processing instance i.

Because the unified machine learning model was trained on historical data across the processing instances 224-1 through 224-n or over workloads that may be different from the ones executing when power for the processing instances is determined, the machine learning model may exhibit some amount of model error from processing instance to processing instance. Accordingly, the computer 102 may adjust the estimated power consumption determined for a processing instance 224 based on an estimated error for the unified machine learning model according to:

$${P}_{attr} ( {PI}_{i} ) = \frac{{P}_{est} ( {PI}_{i} )}{{\sum }_{k} {P}_{est} ( {PI}_{k} )} \times {P}_{meas} ( P r o c )$$

where the adjusted power consumption Pₐₜₜᵣ of processing instance i is determined as the product of the estimated power consumption Pₑₛₜ of processing instance i over the sum of the estimated power consumptions Pₑₛₜ of processing instances k (e.g., the processing instances 224-1 through 224-n) and the measured power consumption of the parallel processor device 204.

In some implementations, the computer 102 uses per-instance machine learning models to estimate the power consumption of processing instances 224-1 through 224-n. In other words, the computer 102 may select a machine learning model for each processing instance 224 so that the machine learning models selected for each of the processing instances 224-1 through 224-n achieves a low model error for the estimated power consumptions for each of the processing instances 224-1 through 224-n.

In some implementations, the computer 102 trains the machine learning model for a particular processing instance 224 using historical executions on the whole parallel processor device 204 of the workload currently executing on the processing instance 224. In this way, the machine learning model can more accurately estimate the power consumption of the processing instance 224 in that the machine learning model was trained on the most relevant data for that processing instance 224.

As an example, the computer 102 may train a machine learning model for a processing instance 224 that is to handle a genAI workload (e.g., which may include a large language model (LLM) workload) may be trained on historical genAI workloads and historical power consumption values on parallel processor device 204. Moreover, the machine learning model may be trained on additional parameters of the genAI workload, such as the type of genAI model (e.g., encoder, decoder, encoder-decoder), the quantity of LLM model parameters accommodated by the genAI model, the quantity of layers of the genAI model, the average quantity of input and output tokens handled by the LLM model, the quantity of inferences the genAI model is expected to serve over a particular time period, a quantization level, and/or a quantity of attention data points, among other examples.

In some implementations, the computer 102 may retrain or update a machine learning model (e.g., a unified machine learning model, a per-instance machine learning model) that is used for estimating the power consumption of processing instances 224-1 through 224-n. For example, the computer 102 may detect a change in the workload (e.g., a change in the workload type, a change in the workload profile) for a processing instance 224, and may build a new model or retrain the last used machine learning model based on detecting the change. The computer 102 may build the new model or retrain the last used machine learning model using data collected based on the changes or modifications in the workload handled by the processing instance 224.

FIGS. 3A and 3B are provided as an example. Other examples may differ from what is described with regard to FIGS. 3A and 3B.

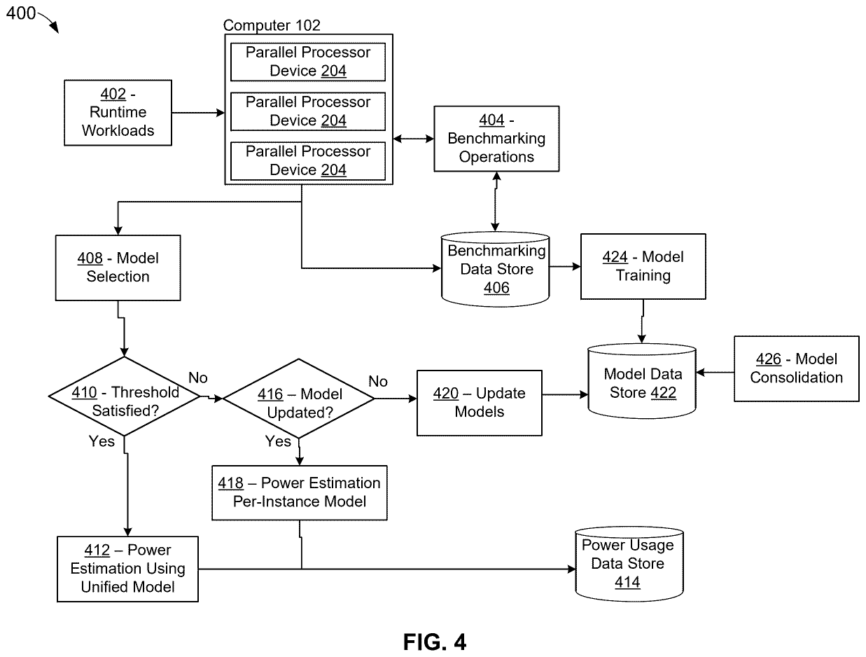

FIG. 4 is a diagram of an example implementation 400 of power utilization approximation across a plurality of processing instances of a parallel processor. The example implementation 400 may include an example of a machine learning model technique for power utilization approximation across a plurality of processing instances 224 of a parallel processor device 204 of a computer 102.

At reference number 402, the computer 102 may receive and process a plurality of runtime workloads. The runtime workloads may be distributed across a plurality of processing instances 224 of a parallel processor device 204 of the computer 102. The runtime workloads may include VM session workloads, generative AI workloads, neural network workloads, and/or another type of workloads.

At reference number 404, benchmarking operations may be performed to benchmark the performance of various machine learning models that may be used to estimate or approximate power utilization across a plurality of processing instances 224 of a parallel processor device 204 of the computer 102. Benchmarking may be on a non-partitioned full parallel processor device 204 also. The computer 102 may store benchmarking data for the benchmarking operations in a benchmarking data store 406. The benchmarking data store 406 may be implemented by storage 134 of the computer 102 and/or by the container set 148 of the public cloud 110 (or private cloud 112), among other examples.

At reference number 408, the computer 102 may select a machine learning model for estimating or approximating power utilization across a plurality of processing instances 224 of a parallel processor device 204 of the computer 102. The computer 102 may select a machine learning model such as a Random Forest model or a Gradient Boosting model that has been trained on a dataset that includes historical utilization metrics and corresponding historical aggregate power consumption values for the plurality of processing instances 224. The dataset may include data from a plurality of workloads handled by the plurality of processing instances 224 and associated historical aggregate power consumption values.

At reference number 410, the computer 102 may determine an estimated error percentage of the selected machine learning model for determining a plurality of estimated power consumption values for workload types for the processing instances 224, and may determine whether the estimated error percentage of the selected machine learning model satisfies an error percentage threshold. If the computer 102 determines that the estimated error percentage satisfies the error percentage threshold (410—Yes), the computer 102 may use the selected machine learning model as a unified machine learning model for estimating power usage across the processing instances 224 at reference number 412. The computer 102 may adjust the estimated power consumption values based on the estimated error percentage of the machine learning model.

The computer 102 may store the estimated (or approximated) power consumption values for the plurality of processing instances 224 in a power usage data store 414. The power usage data store 414 may be implemented by storage 134 of the computer 102 and/or by the container set 148 of the public cloud 110 (or private cloud 112), among other examples.

If the computer 102 determines that the estimated error percentage does not satisfy the error percentage threshold (410—No), the computer 102 may determine whether the model has been updated to account for changes or modifications in the workloads handled by the processing instances 224 at reference number 416.

If the computer 102 determines that the selected machine learning model has been updated to account for changes or modifications in the workloads handled by the processing instances 224 (416—Yes), the computer 102 may use per-instance machine learning models (e.g., the computer 102 may select machine learning models for each of the processing instances 224 that satisfy the error percentage threshold or a model that uses per-instance utilization values as features instead of the aggregate utilization value of the parallel processor device) to estimate the power usage of each processing instance 224 at reference number 418. The computer 102 may store the estimated (or approximated) power consumption values for the plurality of processing instances 224 in a power usage data store 414.

If the computer 102 determines that the selected machine learning model has been not updated to account for changes or modifications in the workloads handled by the processing instances 224 (416—No), the computer 102 may update the machine learning model (or build a new machine learning model) at reference number 420 after collecting sufficient data on the changes or modifications in the workloads handled by the processing instances 224. The computer 102 may store the updated machine learning model in a model data store 422. The model data store 422 may be implemented by storage 134 of the computer 102 and/or by the container set 148 of the public cloud 110 (or private cloud 112), among other examples.

At reference number 424, the computer 102 may train, retrain, and/or update the selected machine learning model(s) based on the outcome of the power consumption estimation for the processing instances 224, and/or based on the benchmarking data stored in the benchmarking data store 406, among other examples. The trained, retrained, and/or updated machine learning model(s) may be stored in the model data store 422 for subsequent use. At reference number 426, the computer 102 may intake and consolidate additional models that may be selected for power consumption estimation for the processing instances 224.

In this way, total power consumption of a parallel processor device 204 may be apportioned among processing instances 224, each of which may execute workloads of different clients in a cloud environment. The workloads may include AI and LLM inferencing and training jobs, among other examples. The computer 102 may perform benchmarking using common and most-used workloads and AI and LLM inferencing jobs to collect data for power characterization. The computer 102 may construct a set of power models for the whole parallel processor device 204 on statistically distinct data sets. The computer 102 may determine the power model from the power model sets with the least error (e.g., using the utilization metrics as well as whole parallel processing device 204 measured power) with respect to the workloads executing at a given time. The computer 102 may apportion power among processing instances 224 using the power model with least error selected if the error is below a threshold. The computer 102 may construct a new model for a workload after collecting sufficient data. The computer 102 may add the power model constructed into the set of power models and also may use it for power apportioning power consumption among processing instances 224.

The computer 102 may use the power model chosen to estimate the total (e.g., active+idle) power consumption for each processing instance 224 after normalizing their utilization metrics in proportion to their sizes. The computer 102 may use the estimated power consumption and the total power consumption of the parallel processor device 204 to compute the power to be attributed to each processing instance 224. The computer 102 may use the per-slice utilization vectors as features to estimate parallel processor device 204 power consumption. The computer 102 may construct a power model for a parallel processor device 204 using per-slice utilization vectors of the processing instances at run-time and may use it for apportioning power consumption among the processing instances 224.

The computer 102 may consolidate the model set when new data becomes available by applying statistical tools such as KL-divergence. The computer 012 may apportion power consumption for processing instances 224 that are specialized for AI and LLM-based Gen-AI workloads that considers attributes of the AI/Gen-AI workloads such as the model type, model size (#of model parameters), #of layers, attention heads, avg. #of input and output tokens, inference serving rate, and quantization level to estimate power and perform power apportioning.

FIG. 4 is provided as an example. Other examples may differ from what is described with regard to FIG. 4.

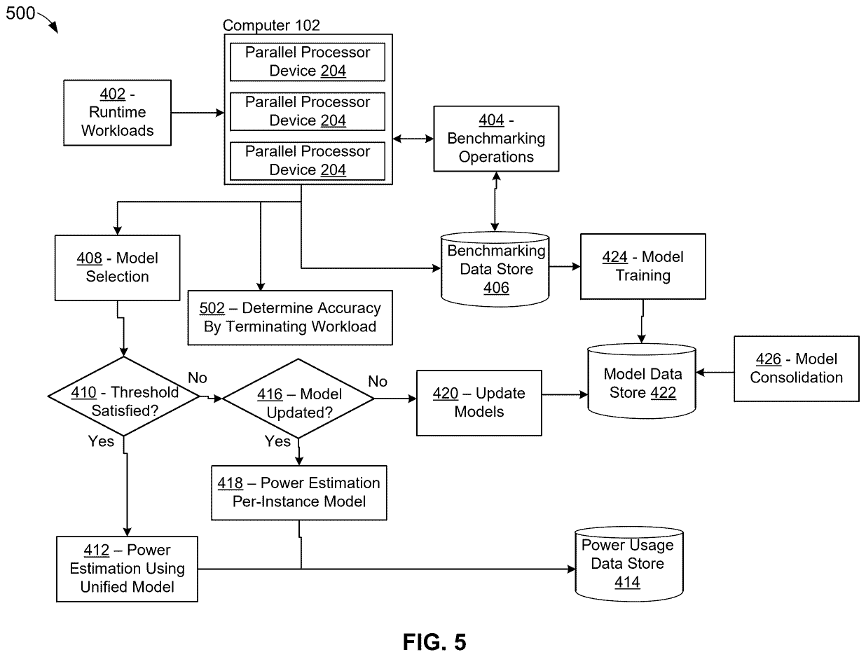

FIG. 5 is a diagram of an example implementation 500 of power utilization approximation across a plurality of processing instances of a parallel processor. The example implementation 500 may include an example of a machine learning model technique for power utilization approximation across a plurality of processing instances 224 of a parallel processor device 204 of a computer 102.

As shown in FIG. 5, the example implementation 500 is similar to the example implementation 400, except that the example implementation 500 includes the computer 102 determining validating the accuracy of a machine learning model when workloads of processing instances terminate, at reference number 502. The computer 102 may validate the accuracy of the outcome of the power consumption estimation, that were determined using a machine learning model, for the processing instances 224 by observing the changes in power consumption when the workloads of processing instances 224 terminate. For example, the computer 102 may associate an accuracy metric with each estimated power consumption value for each processing instance 224 by comparing the drop in aggregate power of the parallel processor device 204 to the active power attributed to a workload (e.g., during a short interval before the workload terminates).

FIG. 5 is provided as an example. Other examples may differ from what is described with regard to FIG. 5.

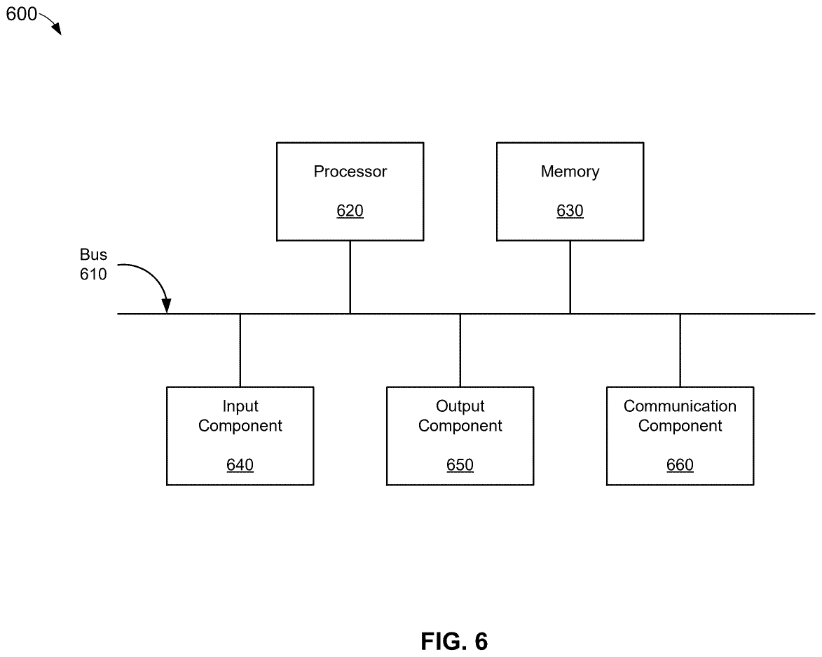

FIG. 6 is a diagram of example components of a device 600 associated with power utilization approximation across a plurality of processing instances of a parallel processor. The device 600 may correspond to one or more devices in computing environment 100 of FIG. 1, such as computer 102, EUD 106, remote server 108, public cloud 110, and/or private cloud 112, among other examples. In some implementations, one or more devices in computing environment 100 of FIG. 1, such as computer 102, EUD 106, remote server 108, public cloud 110, and/or private cloud 112, among other examples, may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus.

The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein. In some implementations, the device 600 includes a plurality of processors 620 that correspond to the general processor device 202 and the plurality of parallel processor devices 204 of a computer 102.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630. In some implementations, the device 600 includes a plurality of memories 630, and at least a subset of the memories 630 are included in the processors 620 (e.g., as the cache 218, the RAM 220, and/or the registers 222, among other examples).

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna. In some implementations, the device 600 includes a plurality of input components 640 and a plurality of output components 650, and at least a subset of the input components 640 and at least a subset of the output components 650 are included in the processors 620 (e.g., as the I/O resources 210).

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

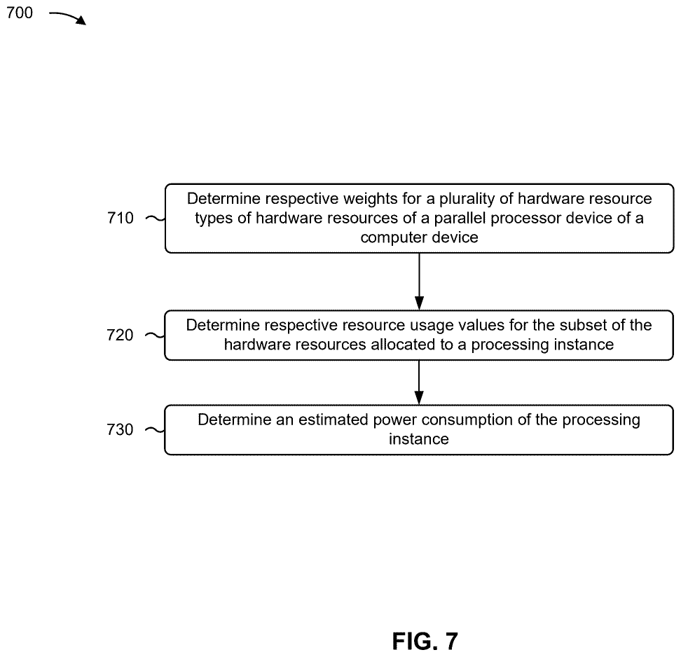

FIG. 7 is a flowchart of an example process 700 associated with power utilization approximation across a plurality of processing instances of a parallel processor. In some implementations, one or more process blocks of FIG. 7 are performed by a computer (e.g., computer 102). In some implementations, one or more process blocks of FIG. 7 are performed by another device or a group of devices separate from or including the computer 102, such as an EUD (e.g., EUD 106), a remote server (e.g., a remote server 108), a public cloud (e.g., a public cloud 110), a private cloud (e.g., a private cloud 112), a processor set (e.g., a processor set 114), a general processor device (e.g., a general processor device 202), a parallel processor device (e.g., a parallel processor device 204) and/or a device (e.g., a device 600), among other examples. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include determining respective weights for a plurality of hardware resource types of hardware resources of a parallel processor device of the computer device (block 710). For example, the computer 102 may determine respective weights for a plurality of hardware resource types of hardware resources of a parallel processor device of the computer device, as described herein. In some implementations, a processing instance, of a plurality of processing instances of the parallel processor device, is allocated a subset of the hardware resources of the parallel processor device. In some implementations, the subset of the hardware resources of the parallel processor device allocated to the processing instance includes each of the plurality of hardware resource types.

As further shown in FIG. 7, process 700 may include determining respective resource usage values for the subset of the hardware resources allocated to the processing instance (block 720). For example, the computer 102 may determine respective resource usage values for the subset of the hardware resources allocated to the processing instance, as described herein. In some implementations, each resource usage value of the respective resource values is associated with a hardware resource type of the plurality of the hardware resource types.

As further shown in FIG. 7, process 700 may include determining an estimated power consumption of the processing instance (block 730). For example, the computer 102 may determine an estimated power consumption of the processing instance, as described herein. In some implementations, the estimated power consumption is based on the respective resource usage values for the subset of the hardware resources allocated to the processing instance and based on the respective weights for the plurality of hardware resource types.

Process 700 may include additional implementations, such as any single implementation or any combination of implementations described below and/or in connection with one or more other processes described elsewhere herein.

In a first implementation, determining the respective weights for the plurality of hardware resource types includes determining the respective weights for scalar operation processing core resources, mixed-precision matrix operation processing core resources, memory resources, and input/output resources.

In a second implementation, alone or in combination with the first implementation, determining the respective resource usage values for the subset of the hardware resources allocated to the processing instance includes determining a resource usage value for a plurality of floating-point operation processing cores of the parallel processor device allocated to the processing instance, determining a resource usage value for a plurality of integer operation processing cores of the parallel processor device, determining a resource usage value for a plurality of mixed-precision matrix operation processing cores of the parallel processor device, and determining a resource usage value for a plurality of memory slices of the parallel processor device.

In a third implementation, alone or in combination with one or more of the first and second implementations, process 700 includes determining a scaled resource utilization value for the processing instance based on the respective resource usage values for the subset of the hardware resources allocated to the processing instance, where determining the estimated power consumption of the processing instance includes determining the estimated power consumption of the processing instance based on the scaled resource utilization value.

In a fourth implementation, alone or in combination with one or more of the first through third implementations, determining the scaled resource utilization value for the processing instance includes determining a resource utilization of the subset of the hardware resources allocated to the processing instance based on the respective resource usage values, and determining the scaled resource utilization value based on the resource utilization of the subset of the hardware resources and based on a relative amount of the hardware resources of the parallel processor device allocated to the subset of the hardware resources.

In a fifth implementation, alone or in combination with one or more of the first through fourth implementations, process 700 includes determining an estimated idle power consumption of the processing instance based on an idle power consumption of the parallel processor device and based on a relative amount of the hardware resources of the parallel processor device allocated to the subset of the hardware resources, where determining the estimated power consumption of the processing instance includes determining the estimated power consumption of the processing instance based on the estimated idle power consumption.

In a sixth implementation, alone or in combination with one or more of the first through fifth implementations, determining the estimated power consumption of the processing instance includes determining an active power consumption of the parallel processor device, determining an estimated active power consumption of the processing instance based on the active power consumption of the parallel processor device and based on the respective resource usage values for the subset of the hardware resources allocated to the processing instance and the respective weights for the plurality of hardware resource types, and determining the estimated power consumption of the processing instance based on the estimated idle power consumption of the processing instance and based on the estimated active power consumption of the processing instance.

In a seventh implementation, alone or in combination with one or more of the first through sixth implementations, determining the estimated active power consumption of the processing instance includes determining the estimated active power consumption of the processing instance based on respective weights applied to an overall resource utilization value aggregated for the plurality of processing instances.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

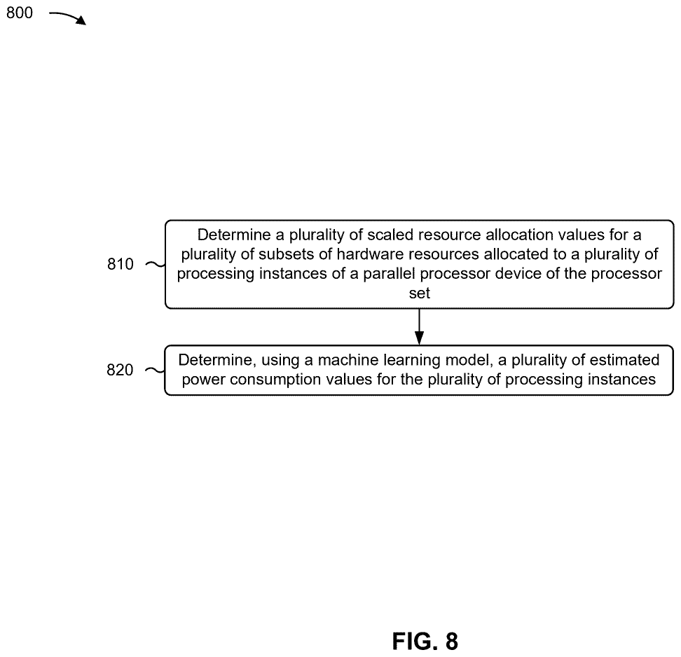

FIG. 8 is a flowchart of an example process 800 associated with power utilization approximation across a plurality of processing instances of a parallel processor. In some implementations, one or more process blocks of FIG. 8 are performed by a computer (e.g., computer 102). In some implementations, one or more process blocks of FIG. 8 are performed by another device or a group of devices separate from or including the computer 102, such as an EUD (e.g., EUD 106), a remote server (e.g., a remote server 108), a public cloud (e.g., a public cloud 110), a private cloud (e.g., a private cloud 112), a processor set (e.g., a processor set 114), a general processor device (e.g., a general processor device 202), a parallel processor device (e.g., a parallel processor device 204) and/or a device (e.g., a device 600), among other examples. Additionally, or alternatively, one or more process blocks of FIG. 7 may be performed by one or more components of device 600, such as processor 620, memory 630, input component 640, output component 650, and/or communication component 660.

As shown in FIG. 8, process 800 may include determining a plurality of scaled resource allocation values for a plurality of subsets of hardware resources allocated to a plurality of processing instances of a parallel processor device of the processor set (block 810). For example, the computer 102 may determine a plurality of scaled resource allocation values for a plurality of subsets of hardware resources allocated to a plurality of processing instances of a parallel processor device of the processor set, as described herein. In some implementations, the plurality of subsets of hardware resources are allocated from hardware resources of the parallel processor device of the processor set. In some implementations, each processing instance, of the plurality of processing instances, is allocated a subset of hardware resources of the plurality of subsets of hardware resources of the parallel processor device. In some implementations, each processing instance, of the plurality of processing instances, is assigned a scaled resource allocation value of the plurality of scaled resource allocation values.

As further shown in FIG. 8, process 800 may include determining, using a machine learning model, a plurality of estimated power consumption values for the plurality of processing instances (block 820). For example, the computer 102 may determine, using a machine learning model, a plurality of estimated power consumption values for the plurality of processing instances, as described herein. In some implementations, each processing instance, of the plurality of processing instances, is assigned an estimated power consumption value of the plurality of estimated power consumption values. In some implementations, the plurality of estimated power consumption values are determined based on the plurality of scaled resource allocation values. In some implementations, the machine learning model is trained on a dataset including historical utilization metrics and corresponding historical power consumption values for the plurality of processing instances.

Process 800 may include additional implementations, such as any single implementation or any combination of implementations described below and/or in connection with one or more other processes described elsewhere herein.

In a first implementation, determining the plurality of estimated power consumption values includes removing idle power values from the plurality of estimated power consumption values.

In a second implementation, alone or in combination with the first implementation, the machine learning model is a unified model trained on data from a plurality of workloads of the plurality of processing instances.

In a third implementation, alone or in combination with one or more of the first and second implementations, process 800 includes determining that an estimated error percentage of the machine learning model for determining the plurality of estimated power consumption values for workload types for the processing instances satisfies an error percentage threshold, and determining to use the machine learning model to determine the plurality of estimated power consumption values based on determining that the estimated error percentage of the machine learning model satisfies the error percentage threshold.

In a fourth implementation, alone or in combination with one or more of the first through third implementations, determining the plurality of estimated power consumption values includes adjusting the plurality of estimated power consumption values based on the estimated error percentage of the machine learning model.

In a fifth implementation, alone or in combination with one or more of the first through fourth implementations, process 800 includes determining a change in workload composition of the plurality of workloads, and updating the machine learning model based on the change in workload composition.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

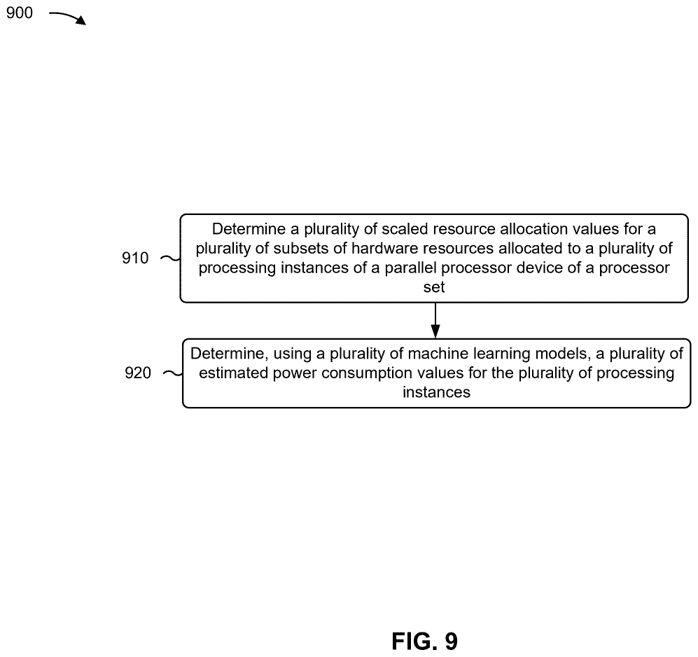

FIG. 9 is a flowchart of an example process 900 associated with power utilization approximation across a plurality of processing instances of a parallel processor. In some implementations, one or more process blocks of FIG. 9 are performed by a computer (e.g., computer 102). In some implementations, one or more process blocks of FIG. 9 are performed by another device or a group of devices separate from or including the computer 102, such as an EUD (e.g., EUD 106), a remote server (e.g., a remote server 108), a public cloud (e.g., a public cloud 110), a private cloud (e.g., a private cloud 112), a processor set (e.g., a processor set 114), a general processor device (e.g., a general processor device 202), a parallel processor device (e.g., a parallel processor device 204) and/or a device (e.g., a device 600), among other examples. Additionally, or alternatively, one or more process blocks of FIG. 9 may be performed by one or more components of device 600, such as processor 620, memory 630, input component 640, output component 650, and/or communication component 660.

As shown in FIG. 9, process 900 may include determining a plurality of scaled resource allocation values for a plurality of subsets of hardware resources allocated to a plurality of processing instances of a parallel processor device of a processor set (block 910). For example, the computer 102 may determine a plurality of scaled resource allocation values for a plurality of subsets of hardware resources allocated to a plurality of processing instances of a parallel processor device of a processor set, as described herein. In some implementations, the plurality of subsets of hardware resources are allocated from hardware resources of the parallel processor device of the processor set. In some implementations, each processing instance, of a plurality of processing instances, is allocated a subset of hardware resources of the plurality of subsets of hardware resources of the parallel processor device. In some implementations, each processing instance, of a plurality of processing instances, is assigned a scaled resource allocation value of the plurality of scaled resource allocation values.

As further shown in FIG. 9, process 900 may include determining, using a plurality of machine learning models, a plurality of estimated power consumption values for the plurality of processing instances (block 920). For example, the computer 102 may determine, using a plurality of machine learning models, a plurality of estimated power consumption values for the plurality of processing instances, as described herein. In some implementations, each processing instance, of a plurality of processing instances, is assigned an estimated power consumption value of the plurality of estimated power consumption values. In some implementations, the plurality of estimated power consumption values are determined based on the plurality of scaled resource allocation values. In some implementations, respective workload compositions, for each of the processing instances of the plurality of processing instances, are used to train the plurality of machine learning models.

Process 900 may include additional implementations, such as any single implementation or any combination of implementations described below and/or in connection with one or more other processes described elsewhere herein.

In a first implementation, the plurality of machine learning models includes a first machine learning model that is used to determine a first estimated power consumption value of the plurality of estimated power consumption values for a first processing instance of the plurality of processing instances, and a second machine learning model that is used to determine a first estimated power consumption value of the plurality of estimated power consumption values for the first processing instance of the plurality of processing instances, where the first machine learning model is trained on first historical training data obtained using a first workload associated with the first processing instance, and where the second machine learning model is trained on second historical training data obtained using a second workload associated with the second processing instance.

In a second implementation, alone or in combination with the first implementation, process 900 includes determining that an estimated error percentage of a unified machine learning model, for use in determining all of the plurality of estimated power consumption values for the plurality of processing instances, does not satisfy an error percentage threshold, and determining to use the plurality of machine learning models to determine the plurality of estimated power consumption values based on determining that the estimated error percentage of the unified machine learning model does not satisfy the error percentage threshold.

In a third implementation, alone or in combination with one or more of the first and second implementations, the parallel processor device is a graphics processor device, and where determining the plurality of scaled resource allocation values for the plurality of subsets of hardware resources includes determining the plurality of scaled resource allocation values for the plurality of subsets of hardware resources based on a plurality of hardware resource types, of the graphics processor device, allocated to the plurality of subsets of hardware resources.

In a fourth implementation, alone or in combination with one or more of the first through third implementations, the plurality of hardware resource types includes scalar operation processing core resources, mixed-precision matrix operation processing core resources, memory resources, and input/output resources.

In a fifth implementation, alone or in combination with one or more of the first through fourth implementations, at least one processing instance of the plurality of processing instances is configured to process an AI workload composition, and where a machine learning model, of the plurality of machine learning models, that is used for the at least one processing instance was trained on a plurality of historical AI workloads and associated historical power consumption values.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
determining, by a processor set of a computer device, respective weights for a plurality of hardware resource types of hardware resources of a parallel processor device of the computer device,
wherein a processing instance, of a plurality of processing instances of the parallel processor device, is allocated a subset of the hardware resources of the parallel processor device, and
wherein the subset of the hardware resources of the parallel processor device allocated to the processing instance includes each of the plurality of hardware resource types;
determining, by the processor set, respective resource usage values for the subset of the hardware resources allocated to the processing instance,
wherein each resource usage value of the respective resource values is associated with a hardware resource type of the plurality of the hardware resource types; and
determining, by the processor set, an estimated power consumption of the processing instance,
wherein the estimated power consumption is based on the respective resource usage values for the subset of the hardware resources allocated to the processing instance and based on the respective weights for the plurality of hardware resource types.

2. The computer-implemented method of claim 1, wherein the determining the respective weights for the plurality of hardware resource types comprises:
determining the respective weights for:
scalar operation processing core resources;
mixed-precision matrix operation processing core resources;
memory resources; and
input/output resources.

3. The computer-implemented method of claim 1, wherein the determining the respective resource usage values for the subset of the hardware resources allocated to the processing instance comprises:
determining a resource usage value for a plurality of floating-point operation processing cores of the parallel processor device allocated to the processing instance;
determining a resource usage value for a plurality of integer operation processing cores of the parallel processor device;
determining a resource usage value for a plurality of mixed-precision matrix operation processing cores of the parallel processor device; and
determining a resource usage value for a plurality of memory slices of the parallel processor device.

4. The computer-implemented method of claim 1, further comprising:
determining a scaled resource utilization value for the processing instance based on the respective resource usage values for the subset of the hardware resources allocated to the processing instance,
wherein the determining the estimated power consumption of the processing instance comprises:
determining the estimated power consumption of the processing instance based on the scaled resource utilization value.

5. The computer-implemented method of claim 4, wherein the determining the scaled resource utilization value for the processing instance comprises:
determining a resource utilization, by the processing instance, of the subset of the hardware resources allocated to the processing instance based on the respective resource usage values; and
determining the scaled resource utilization value based on the resource utilization of the subset of the hardware resources and based on a relative amount of the hardware resources of the parallel processor device allocated to the subset of the hardware resources.

6. The computer-implemented method of claim 1, further comprising:
determining an estimated idle power consumption of the processing instance based on an idle power consumption of the parallel processor device and based on a relative amount of the hardware resources of the parallel processor device allocated to the subset of the hardware resources,
wherein the determining the estimated power consumption of the processing instance comprises:
determining the estimated power consumption of the processing instance based on the estimated idle power consumption.

7. The computer-implemented method of claim 6, wherein the determining the estimated power consumption of the processing instance comprises:
determining an active power consumption of the parallel processor device;
determining an estimated active power consumption of the processing instance based on the active power consumption of the parallel processor device and based on the respective resource usage values for the subset of the hardware resources allocated to the processing instance and the respective weights for the plurality of hardware resource types; and
determining the estimated power consumption of the processing instance based on the estimated idle power consumption of the processing instance and based on the estimated active power consumption of the processing instance.

8. The computer-implemented method of claim 7, wherein the determining the estimated active power consumption of the processing instance comprises:
determining the estimated active power consumption of the processing instance based on respective weights applied to an overall resource utilization value aggregated for the plurality of processing instances.

9. A computer system, comprising:
a processor set;
one or more computer-readable storage media; and
program instructions stored on the one or more computer-readable storage media to cause the processor set to perform operations comprising:
determining a plurality of scaled resource allocation values for a plurality of subsets of hardware resources allocated to a plurality of processing instances of a parallel processor device of the processor set,
wherein the plurality of subsets of hardware resources are allocated from hardware resources of the parallel processor device of the processor set,
wherein each processing instance, of the plurality of processing instances, is allocated a subset of hardware resources of the plurality of subsets of hardware resources of the parallel processor device, and
wherein each processing instance, of the plurality of processing instances, is assigned a scaled resource allocation value of the plurality of scaled resource allocation values; and
determining, using a machine learning model, a plurality of estimated power consumption values for the plurality of processing instances,
wherein each processing instance, of the plurality of processing instances, is assigned an estimated power consumption value of the plurality of estimated power consumption values,
wherein the plurality of estimated power consumption values are determined based on the plurality of scaled resource allocation values, and
wherein the machine learning model is trained on a dataset comprising historical utilization metrics and corresponding historical power consumption values for the plurality of processing instances.

10. The computer system of claim 9, wherein the determining the plurality of estimated power consumption values comprises:
removing idle power values from the plurality of estimated power consumption values.

11. The computer system of claim 9, wherein the machine learning model is a unified model trained on data from a plurality of workloads of the plurality of processing instances.

12. The computer system of claim 11, wherein the operations further comprise:
determining that an estimated error percentage of the machine learning model for determining the plurality of estimated power consumption values for workload types for the processing instances satisfies an error percentage threshold; and
determining to use the machine learning model to determine the plurality of estimated power consumption values based on determining that the estimated error percentage of the machine learning model satisfies the error percentage threshold.

13. The computer system of claim 12, wherein the determining the plurality of estimated power consumption values comprises:
adjusting the plurality of estimated power consumption values based on the estimated error percentage of the machine learning model.

14. The computer system of claim 11, wherein the operations further comprise:
determining a change in workload composition of the plurality of workloads; and
updating the machine learning model based on the change in workload composition.

15. A computer program product, comprising:
one or more computer-readable storage media; and
program instructions stored on the one or more computer-readable storage media to perform operations comprising:
determining a plurality of scaled resource allocation values for a plurality of subsets of hardware resources allocated to a plurality of processing instances of a parallel processor device of a processor set,
wherein the plurality of subsets of hardware resources are allocated from hardware resources of the parallel processor device of the processor set,
wherein each processing instance, of a plurality of processing instances, is allocated a subset of hardware resources of the plurality of subsets of hardware resources of the parallel processor device, and
wherein each processing instance, of a plurality of processing instances, is assigned a scaled resource allocation value of the plurality of scaled resource allocation values; and
determining, using a plurality of machine learning models, a plurality of estimated power consumption values for the plurality of processing instances,
wherein each processing instance, of a plurality of processing instances, is assigned an estimated power consumption value of the plurality of estimated power consumption values,
wherein the plurality of estimated power consumption values are determined based on the plurality of scaled resource allocation values, and
wherein respective workload compositions, for each of the processing instances of the plurality of processing instances, are used to train the plurality of machine learning models.

16. The computer program product of claim 15, wherein the plurality of machine learning models comprises:
a first machine learning model that is used to determine a first estimated power consumption value of the plurality of estimated power consumption values for a first processing instance of the plurality of processing instances; and
a second machine learning model that is used to determine a first estimated power consumption value of the plurality of estimated power consumption values for the first processing instance of the plurality of processing instances,
wherein the first machine learning model is trained on first historical training data obtained using a first workload associated with the first processing instance, and
wherein the second machine learning model is trained on second historical training data obtained using a second workload associated with the second processing instance.

17. The computer program product of claim 15, wherein the operations further comprise:
determining that an estimated error percentage of a unified machine learning model, for use in determining all of the plurality of estimated power consumption values for the plurality of processing instances, does not satisfy an error percentage threshold; and
determining to use the plurality of machine learning models to determine the plurality of estimated power consumption values based on determining that the estimated error percentage of the unified machine learning model does not satisfy the error percentage threshold.

18. The computer program product of claim 15, wherein the parallel processor device is a graphics processor device; and
wherein the determining the plurality of scaled resource allocation values for the plurality of subsets of hardware resources comprises:
determining the plurality of scaled resource allocation values for the plurality of subsets of hardware resources based on a plurality of hardware resource types, of the graphics processor device, allocated to the plurality of subsets of hardware resources.

19. The computer program product of claim 18, wherein the plurality of hardware resource types comprises:
scalar operation processing core resources;
mixed-precision matrix operation processing core resources;
memory resources; and
input/output resources.

20. The computer program product of claim 15, wherein at least one processing instance of the plurality of processing instances is configured to process an artificial intelligence (AI) workload composition; and
wherein a machine learning model, of the plurality of machine learning models, that is used for the at least one processing instance was trained on a plurality of historical AI workloads and associated historical power consumption values.
